(19) United States
(12) Patent Application Publication
(10) Pub. No.: US 2008/0133323 A1
(43) Pub. Date: Jun. 5, 2008

(54) Generating revenue stream by providing advertisement to targeted populated geographical region

(76) Inventor: Paul H. Willms, Everett, WA (US)

Correspondence Address: THE LAW OFFICES OF BORIS G. TANKHILEVICH, Suite A, 536 N. Civic Drive, Walnut Creek, CA, 94597, US

(21) Appl. No.: 11/633,789

(22) Filed: Dec. 5, 2006

(51) Int. Cl. G07G 1/00

(52) U.S. Cl. 705/10; 701/213; 705/14

(57) ABSTRACT

A method for generating revenue stream by providing an advertisement (ad) to a targeted populated geographical region (PGR), wherein an ad is placed on a mobile carrier. The method comprises: (A) selecting the PGR; (B) selecting a route; (C) selecting an ad; (D) selecting a mobile carrier of the selected ad; (E) targeting the PGR by using the selected carrier of the selected ad; wherein the selected carrier of the ad follows the selected route; and (F) estimating revenue stream originated from the targeted PGR and caused by exposure to the selected ad.

### TECHNICAL FIELD

The present invention relates to the field of advertisement.

### BACKGROUND ART

To date, virtually all of the world's 18 million shipping containers are either painted with the name of the shipping carrier or container leasing company. The main problem precluding the use of containers as advertising space has been the inability to determine the precise location of any specific container, thus preventing the provider from measuring the effectiveness of this form of advertising.

What is needed is to improve the measurement of the effectiveness of this form of advertising.

### DISCLOSURE OF THE INVENTION

The present invention allows one to improve the measurement of the effectiveness of the form of advertising that utilizes a mobile carrier including an advertisement (ad) applied to the external surface of the mobile carrier.

One aspect of the present invention is directed to a method for generating a revenue stream by providing an advertisement (ad) to a targeted populated geographical region (PGR), wherein the selected ad is placed on a mobile carrier.

In one embodiment, the method of the present invention comprises: (A) selecting a PGR; (B) selecting a route; (C) selecting an ad; D) selecting a mobile carrier of the selected ad; (E) targeting the PGR by using the selected carrier of the selected ad; wherein the selected carrier of the selected ad follows the selected route; and (F) estimating the revenue stream originated from the targeted PGR and caused by exposure to the selected ad.

In one embodiment of the present invention, the step (A) further comprises: (A1) selecting a PGR based on a plurality of factors selected from the group consisting of: {country of residence of the PGR; spoken language of the PGR; demographics of the PGR; local variations of the PGR; traffic patterns; and consumer statistics of the PGR}.

In one embodiment of the present invention, the step (B) further comprises: (B1) pre-programming the route of the mobile carrier to target the selected PGR by using a plurality of factors selected from the group consisting of: {demographics of the PGR; local variations of the PGR; traffic patterns; and consumer statistics of the PGR}. In another embodiment of the present invention, the step (B) further comprises: (B2) pre-programming the route of the mobile carrier to target the selected PGR by using a plurality of factors selected from the group consisting of: {a set of particular locations; and distribution of time intervals spent on the set of particular locations}. In one more embodiment of the present invention, the step (B) further comprises: (B3) real-time programming the route based on a set of real-time factors selected from the group consisting of: {maximum real-time engineered exposure; and a set of emerging opportunities}.

In one embodiment of the present invention, the step (C) further comprises: (C1) selecting an ad based on a plurality of factors selected from the group consisting of: {spoken language of the PGR; demographics of the PGR; consumer statistics of the PGR; local variations of the PGR; number of seasons; and time of the day}.

In one embodiment of the present invention, the step (D) further comprises: (D1) selecting the mobile carrier of the selected ad from the group consisting of; {a cargo container; a truck; a personal vehicle; and a means of transportation}.

In one embodiment of the present invention, the step (E) further comprises: (E1) checking whether the mobile carrier follows the selected route by determining real time position coordinates of the mobile carrier by using a position determination device, wherein the position determination device is selected from the group consisting of {a GPS receiver; a GLONASS receiver; a GALILEO receiver; a Global Navigational Satellite System (GNSS) receiver; and a pseudolite receiver}.

In one embodiment of the present invention, the step (E1) further comprises: (E1, 1) sending the real time position coordinates of the mobile carrier to a tracking station; and (E1, 2) recording an actual route of the mobile carrier by the tracking station.

In one embodiment of the present invention, the step (F) further comprises: (F1) estimating the revenue stream originated from the targeted PGR and caused by exposure to the selected ad by using a plurality of factors selected from the group consisting of: {a pre-arrangement agreement between a mobile carrier provider and an ad agency; a poll conducted among population of the PGR; and a model of the revenue stream originated from the targeted PGR and caused by exposure to the selected ad}.

In one embodiment, the method of the present invention further comprises: (G) maximizing the revenue stream originated from the targeted PGR and caused by exposure to the selected ad by changing a plurality of factors selected from the group consisting of: {the selected ad context; the mobile carrier; and the selected route of the carrier of the selected ad context}.

Another aspect of the present invention is directed to a method for generating revenue stream by providing an advertisement (ad) to a targeted populated geographical region (PGR), wherein the selected ad placed on a mobile carrier is related to goods loaded on the mobile carrier, and wherein the selected ad is also indicative of shops where the goods are being delivered.

In one embodiment, the method of the present invention comprises: (A) selecting the PGR; (B) selecting the goods; (C) selecting an ad related to the goods; (D) selecting a mobile carrier of the selected ad; (E) selecting a route; (F) targeting a PGR by using the selected carrier of the selected ad, wherein the selected carrier of the selected ad follows the selected route and delivers the goods; and (G) estimating the revenue stream originated from the targeted PGR from sales of the goods and caused by exposure to the selected ad of the goods.

In one embodiment of the present invention, the step (A) further comprises: (A1) selecting a PGR based on a plurality of factors selected from the group consisting of: {country of residence of the PGR; spoken language of the PGR; demographics of the PGR; local variations of the PGR; traffic patterns; and consumer statistics of the PGR}.

In one embodiment of the present invention, the step (B) further comprises: (B1) selecting the goods by using a plurality of factors selected from the group consisting of: {demographics of the PGR; local variations of the PGR; and consumer statistics of the PGR}.

In one embodiment of the present invention, the step (C) further comprises: (C1) selecting an ad related to the goods by using a plurality of factors selected from the group consisting of: {spoken language of the PGR; demographics of the PGR; consumer statistics of the PGR; local variations of the PGR; number of seasons; and time of the day}.

In one embodiment of the present invention, the step (D) further comprises: (D1) selecting the mobile carrier of the selected ad from the group consisting of; {a cargo container; a truck; a personal vehicle; and a means of transportation}.

In one embodiment of the present invention, the step (E) further comprises: (E1) pre-programming the route of the mobile carrier to target the selected PGR by using a plurality of factors selected from the group consisting of: {demographics of the PGR; local variations of the PGR; traffic patterns; and consumer statistics of the PGR}. In another embodiment of the present invention, the step (E) further comprises: (E2) pre-programming the route of the mobile carrier to target the selected PGR by using a plurality of factors selected from the group consisting of: {a set of particular locations; and distribution of time intervals spent on the set of particular locations}. In one more embodiment of the present invention, the step (E) further comprises: (E3) real-time programming the route based on a set of real-time factors selected from the group consisting of: {new requests for delivery of selected goods; and a set of emerging opportunities}.

In one embodiment of the present invention, the step (F) further comprises: (F1) checking whether the mobile carrier follows the selected route by determining real time position coordinates of the mobile carrier by using a position determination device, wherein the position determination device is selected from the group consisting of {a GPS receiver; a GLONASS receiver; a GALILEO receiver; a Global Navigational Satellite System (GNSS) receiver; and a pseudolite receiver}.

In one embodiment of the present invention, the step (F1) further comprises: (F1, 1) sending the real time position coordinates of the mobile carrier to a tracking station; and (F1, 2) recording an actual route of the mobile carrier by the tracking station.

In one embodiment of the present invention, the step (G) further comprises: (G1) estimating the revenue stream originated from the targeted PGR from sales of goods and caused by exposure to the selected ad of the goods by using a plurality of factors selected from the group consisting of: {a pre-arrangement agreement between a mobile carrier provider and an ad agency; a pre-arrangement agreement between an ad agency and a shopping center where the goods are sold; a poll conducted among population of the PGR; and a model of the revenue stream originated from the targeted PGR and caused by exposure to the selected ad of the goods}.

One more aspect of the present invention is directed to an apparatus for generating revenue stream by providing an advertisement (ad) to a targeted populated geographical region (PGR), wherein the selected ad is placed on a mobile carrier.

In one embodiment, the apparatus of the present invention comprises: (A) a means for selecting the PGR; (B) a means for selecting a route; (C) a means for selecting an ad; (D) a means for selecting a mobile carrier for the selected ad; (E) a means for attaching the selected ad to an external surface of the mobile carrier; (F) a means for checking whether the selected carrier of the selected ad follows the selected route; and (G) a means for estimating the revenue stream originated from the targeted PGR and caused by exposure to the selected ad.

In one embodiment of the present invention, the means (A) further comprises: (A1) a means for selecting a PGR based on a plurality of factors selected from the group consisting of: {country of residence of the PGR; spoken language of the PGR; demographics of the PGR; local variations of the PGR; traffic patterns; and consumer statistics of the PGR}.

In one embodiment of the present invention, the means (B) further comprises: (B1) an algorithm configured to pre-program the route of the mobile carrier to target the selected PGR by using a plurality of factors selected from the group consisting of: {demographics of the selected PGR; local variations of the selected PGR; traffic patterns; and consumer statistics of the selected PGR}. In another embodiment of the present invention, the means (B) further comprises: (B2) an algorithm configured to pre-program the route of the mobile carrier to target the PGR by using a plurality of factors selected from the group consisting of: {a set of particular locations; and distribution of time intervals spent on the set of particular locations}. In one more embodiment of the present invention, the means (B) further comprises: (B3) an algorithm configured to pre-program in real time the route based on a set of real-time factors selected from the group consisting of: {maximum real-time engineered exposure; and a set of emerging opportunities}.

In one embodiment of the present invention, the means (C) further comprises: (C1) an algorithm configured to select an ad based on a plurality of factors selected from the group consisting of: {spoken language of the PGR; demographics of the PGR; consumer statistics of the PGR; local variations of the PGR; number of seasons; and time of the day}.

In one embodiment of the present invention, the means (D) further comprises: (D1) an algorithm configured to select a mobile carrier of the selected ad from the group consisting of; {a cargo container; a truck; a personal vehicle; and a means of transportation}.

In one embodiment of the present invention, the means (E) further comprises: (E1) a means for attaching the selected ad to an external surface of the mobile carrier by using a plastic insert configured to flatten out the external surface of the mobile carrier.

In one embodiment of the present invention, the means (E) further comprises: (E2) a rack mounted printer head configured to print the selected ad on an external surface of the mobile carrier.

In one embodiment of the present invention, the means (F) further comprises: (F1) a position determination device configured to verify whether the selected carrier of the selected ad follows the selected route; wherein the position determination device is selected from the group consisting of {a GPS receiver; a GLONASS receiver; a GALILEO receiver; a Global Navigational Satellite System (GNSS) receiver; and a pseudolite receiver}.

In one embodiment of the present invention, the means (F) further comprises: (F2) a transceiver configured to send the real time position coordinates of the mobile carrier to a tracking station; wherein the tracking station is configured to record an actual route of the mobile carrier.

In one embodiment of the present invention, the means (G) further comprises: (G1) an algorithm configured to estimate the revenue stream originated from the targeted PGR and caused by exposure to the selected ad by using a plurality of factors selected from the group consisting of: {a pre-arrangement agreement between a mobile carrier provider and an ad agency; a poll conducted among population of the PGR; and a model of the revenue stream originated from the targeted PGR and caused by exposure to the selected ad}.

In one embodiment, the apparatus of the present invention further comprising: (H) a means for maximizing the revenue stream originated from the targeted PGR and caused by exposure to the selected ad by changing a plurality of factors selected from the group consisting of: {the selected ad context; the mobile carrier; and the selected route of the carrier of the selected ad context}.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 illustrates the flow chart of the method of the present invention for generating revenue stream by providing advertisement to targeted populated geographical region (PGR).

FIG. 2 is a flow chart of the method of the present invention for generating revenue stream by providing an advertisement to targeted populated geographical region (PGR), wherein the selected ad placed on a mobile carrier is related to goods loaded on the mobile carrier.

FIG. 3 depicts the apparatus of the present invention for generating revenue stream by providing an advertisement (ad) to a targeted populated geographical region (PGR).

FIG. 4 illustrates a container having five modular panels shown assembled and ready for mounting of advertisement martial for the purposes of the present invention.

FIG. 5 is an exploded view of assembly process that illustrates how five modular panels can be attached to the container to create a subsurface to mount various forms of advertisement for the purposes of the present invention.

FIG. 6 shows how a modular extrusion (plastic or other material) fits in the corrugation of a standard container outer wall for the purposes of the present invention.

### BEST MODE FOR CARRYING OUT THE INVENTION

Reference now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific-details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

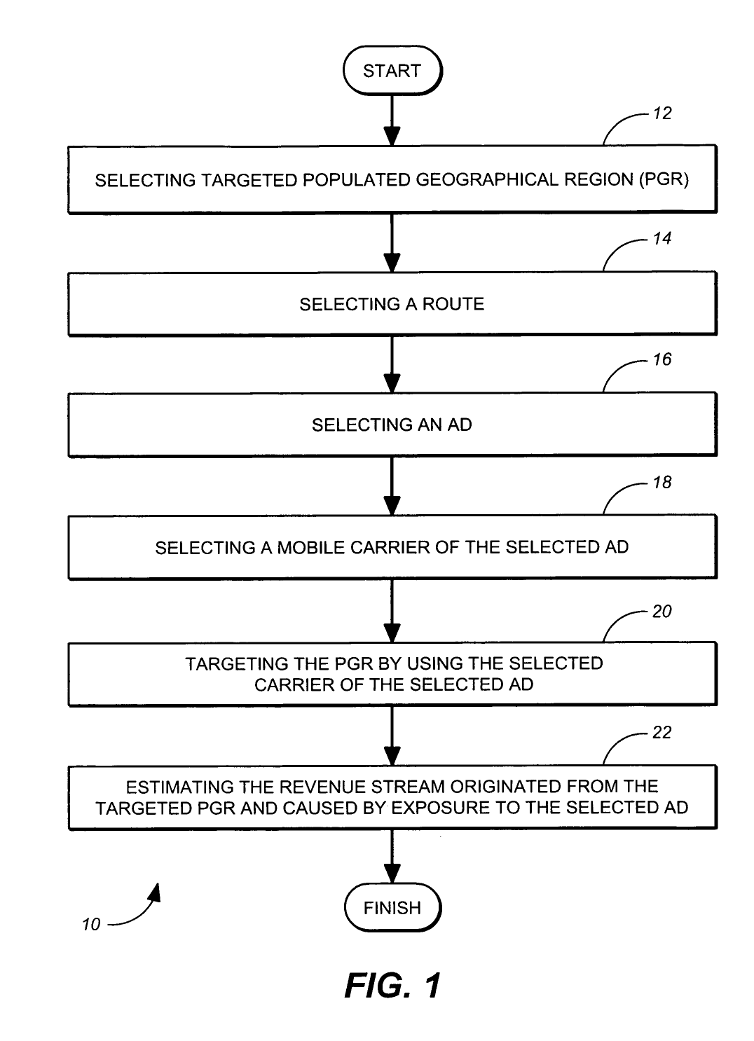

FIG. 1 illustrates the flow chart 10 of the method of the present invention for generating revenue stream by providing an advertisement (ad) to a targeted populated geographical region (PGR).

In one embodiment, as depicted in FIG. 1, the method of the present invention comprises the following steps: (A) selecting a PGR (step 12); (B) selecting a route (step 14); (C) selecting an ad (step 16); D) selecting a mobile carrier of the selected ad (step 18); (E) targeting the PGR by using the selected carrier of the selected ad, wherein the selected carrier of the selected ad follows the selected route (step 20); and (F) estimating the revenue stream originated from the targeted PGR and caused by exposure to the selected ad (step 22).

In one embodiment of the present invention, the step (A) further comprises (not shown): (A1) selecting a PGR based on a plurality of factors selected from the group consisting of: {country of residence of the PGR; spoken language of the PGR; demographics of the PGR; local variations of the PGR; traffic patterns; and consumer statistics of the PGR}.

### Country of Residence of the PGR.

For the purposes of the present invention, the algorithm configured to estimate revenue stream caused by providing an advertisement (ad) to a targeted PGR should include an artificial intelligence (AI) engine configured to select, or take into account the selected country of residence of the PGR.

In one embodiment of the present invention, if the mobile carrier is a shipment container that is being shipped from country A to country B via sea (or/and ocean) route, the relevant country of residence of the PGR is the country of destination B. Different countries have different traditions, consumer statistics, spoken languages, etc. To generate a sizeable revenue stream by providing advertisement (ad) to the targeted PGR the ad's provider has to take into account all these factors. One important example: if a country of residence of the PGR is an Islamic country in Asia, the ad provider should avoid an ad context including women models in bikinis because more than 69% of the population is Muslims (Table II). On the other hand, if one ships a container to a country in Oceania, the issue is moot because only 0.025% of population is Muslims (Table V).

TABLE I
Islam in Africa

| | Total | | % | % of Muslim |
|---|---|---|---|---|
| Region | Population | Muslims | Muslim | total |
| Central Africa | 83,121,055 | 12,582,592 | 15.138% | 0.852% |
| East Africa | 193,741,900 | 66,381,242 | 34.263% | 4.497% |
| North Africa | 202,151,323 | 180,082,076 | 89.083% | 12.199% |
| Southern | 137,092,019 | 8,935,043 | 6.518% | 0.605% |
| Africa | | | | |
| West Africa | 268,997,245 | 133,994,675 | 49.813% | 9.077% |
| Total | 885,103,542 | 401,975,628 | 45.416% | 27.23% |

TABLE II
Islam in Asia

| | Total | | % | % of Muslim |
|---|---|---|---|---|
| Region | Population | Muslims | Muslim | total |
| Central Asia | 92,019,166 | 76,105,962 | 82.707% | 5.155% |
| East Asia | 1,527,960,261 | 39,609,350 | 2.592% | 2.683% |
| Middle East | 274,775,527 | 252,219,832 | 91.791% | 17.085% |
| South Asia | 1,437,326,682 | 456,062,641 | 28.947% | 28.184% |
| Southeast | 571,337,070 | 239,566,220 | 41.931% | 16.228% |
| Asia | | | | |
| Total | 3,903,418,706 | 1,023,564,005 | 26.222% | 69.336% |

TABLE III
Islam in Europe

| | Total | | % | % of Muslim |
|---|---|---|---|---|
| Region | Population | Muslims | Muslim | total |
| Balkans | 65,407,609 | 8,165,137 | 12.483% | 0.553% |
| Central Europe | 74,510,241 | 521,284 | 0.7% | 0.035% |
| Eastern Europe | 212,821,296 | 21,826,829 | 10.256% | 1.479% |
| Western Europe | 375,832,557 | 13,577,116 | 3.613% | 0.92% |
| Total | 728,571,703 | 44,090,366 | 6.052% | 2.987% |

TABLE IV
Islam in North America and Islam in South America

| | Total | | % | % of Muslim |
|---|---|---|---|---|
| Region | Population | Muslims | Muslim | total |
| Caribbean | 23,809,622 | 15,860 | 0.067% | 0.001% |
| Central | 42,223,849 | 84,035 | 0.199% | 0.006% |
| America | | | | |
| North America | 446,088,748 | 5,115,892 | 1.147% | 0.347% |
| South America | 371,075,531 | 1,014,716 | 0.273% | 0.069% |
| Total | 883,197,750 | 6,230,503 | 0.705% | 0.422% |

TABLE V
Islam in Oceania

| | Total | | % | % of Muslim |
|---|---|---|---|---|
| Region | Population | Muslims | Muslim | total |
| Oceania | 30,564,520 | 372,968 | 1.22% | 0.025% |

### Spoken Language of the PGR

In one embodiment of the present invention, the algorithm configured to estimate revenue stream caused by providing an advertisement (ad) to a targeted PGR should include AI engine configured to take into account the spoken language of the selected PGR.

For instance, Chinese is distinguished for a high level of internal diversity. Regional variation between different variants/dialects is comparable to the Romance language family; many variants of spoken Chinese are different enough to be mutually incomprehensible. There are between six and twelve main regional groups of Chinese (depending on classification scheme), of which the most populous by far is Mandarin (800 million), followed by Wu (90 million), and Cantonese (80 million). Thus, depending on the destination of the shipping container the ad provider will do well if he takes into account the local variations. This is exceedingly important if an ad context includes some form of an audible ad context.

### Demographics of the PGR

In one embodiment of the present invention, the algorithm configured to estimate revenue stream caused by providing an advertisement (ad) to a targeted PGR should take into account Demographics of the selected PGR.

The Demographics is a shorthand term for ‘population characteristics’. Demographics include race, age, income, mobility (in terms of travel time to work or number of vehicles available), educational attainment, home ownership, employment status, and even location. Distributions of values within a demographic variable, and across households, are both of interest, as well as trends over time. Marketers and other social scientists often group populations into categories based on demographic variables. In one embodiment of the present invention, the most important demographic variables are: (age; sex/gender; race/ethnicity; location of residence; socioeconomic status (SES); religion; marital status; ownership (home, car, pet, etc.); language; and mobility' life cycles (fertility, mortality, migration). For instance, if the ad provider targets the general population and a quarter of the population of the targeted PGR is under 15 years old, (Iran), the goods for children under 15 years old should be heavily advertised on the surface of a container without any relationship to the goods that are actually being shipped using this particular mobile carrier.

### Local Variations of the PGR.

In one embodiment of the present invention, the algorithm configured to estimate revenue stream caused by providing an advertisement (ad) to a targeted PGR should include A1 engine configured to take into account local variations of the PGR.

For example, the ad provider should take into account the different weather conditions in different parts of the country and the season of the year when the shipping container will be present in a particular part of the country having a particular weather pattern. In one embodiment of the present invention, the algorithm configured to estimate revenue stream caused by providing an advertisement (ad) to a targeted PGR should include AI engine configured to take into account as many local variations of the PGR as feasible.

### Traffic Patterns.

In one embodiment of the present invention, the algorithm configured to estimate revenue stream caused by providing an advertisement (ad) to a targeted PGR should include AI engine configured to take into account traffic patterns of the targeted PGR.

In many parts of the world traffic is generally organized, flowing in lanes of travel for a particular direction, with junctions, intersections, interchanges, traffic signals, or signs. Traffic may be separated into classes: vehicular; non-vehicular (e.g. bicycles); and pedestrian. Different classes may share speed limits and easement, or may be segregated. Some countries may have very detailed and complex traffic laws while others rely on drivers' common sense and willingness to cooperate. Organization typically reduces travel time. Though vehicles wait at some intersections, wait time at others is much shorter. An unexpected occurrence may cause traffic to degenerate into a disorganized mess: road construction, accidents, or debris may all disrupt the flow. On particularly busy freeways, a minor disruption may persist in a phenomenon known as traffic waves. A complete breakdown of organization may result in traffic jams and gridlock. In one embodiment of the present invention, the algorithm configured to estimate revenue stream should include AI engine configured to use the simulations of organized traffic that involves queuing theory, stochastic processes and equations of mathematical physics as applied to traffic flow.

### Consumer Statistics of the PGR.

In one embodiment of the present invention, the algorithm configured to estimate revenue stream caused by providing an advertisement (ad) to a targeted PGR should include AI engine configured to take into account consumer statistics of the targeted PGR.

The best approach is to use the information provided by the government institution that gathers the statistical information about the country of destination (country B). For example, Statistics Netherlands is a Dutch governmental institution that gathers statistical information about the Netherlands. In Dutch it is known as the “Centraal Bureau voor de Statistiek” and often abbreviated to CBS. It is a department of the Ministry of Economic Affairs. It was founded in 1899.

The CBS collects statistical information about, amongst others:

economic growth;

consumer pricing;

income of persons and households;

count of the population;

unemployment.

All of these factors are relevant because they determine the disposable income of different segments of population of the country of destination (country B).

Thus, the targeted PGR should be selected by the ad provider by carefully researching all relevant above-discussed factors: {country of residence of the PGR; spoken language of the PGR; demographics of the PGR; local variations of the PGR; traffic patterns; and consumer statistics of the PGR}.

After the targeted PGR is selected, referring still to FIG. 1, in one embodiment of the present invention, the step (B) (step 14) of the method of the present invention of selecting a route of the mobile carrier that includes an ad designed to target the selected PGR) further comprises: (B1) pre-programming the route of the mobile carrier to target the selected PGR by using a plurality of factors selected from the group consisting of: {demographics of the PGR; local variations of the PGR; traffic patterns; and consumer statistics of the PGR}.

In one embodiment of the present invention, the algorithm configured to estimate revenue stream caused by providing an advertisement (ad) to a targeted PGR should include AI engine configured to pre-program a route of a mobile carrier as a de-fault option. The pre-programmed route should be selected based on a plurality of factors selected from the group consisting of: {demographics of the PGR; local variations of the PGR; traffic patterns; and consumer statistics of the PGR}. All these factors were discussed above. The essence of the process of route-pre-programming is to minimize all negative factors and to emphasize all positive factors that are relevant to generation of revenue caused by exposure of targeted population to the selected ad. Thus, demographics of the PGR should be considered to select the best ad that would generate the maximum revenue when an advertised product is sold in the targeted area. The route should be pre-programmed in such a way as to minimize the local variations of the PGR within the route. The timing of the pre-programmed route should be such as to minimize the delaying effect of the traffic. Consumer statistics of the PGR should be carefully examined to pre-program a route that would target the population with the largest disposable income which is consistent with zoning requirements.

In another embodiment of the present invention, the step (B) (step 14 of FIG. 1) further comprises: (B2) pre-programming the route of the mobile carrier to target the selected PGR by using a plurality of factors selected from the group consisting of: {a set of particular locations; and distribution of time intervals spent on the set of particular locations}. In this embodiment of the present invention, the real-time schedule is set up for the pre-programmed route by using the set of above-discussed factors {demographics of the PGR; local variations of the PGR; traffic patterns; and consumer statistics of the PGR}. In this embodiment of the present invention, the mobile carrier can be tracked by using the tracking station to determine whether the pre-programmed route was actually followed by the mobile carrier.

In one more embodiment of the present invention, the step (B) (step 14 of FIG. 1) further comprises: (B3) route real-time programming based on a set of real-time factors selected from the group consisting of: {maximum real-time engineered exposure; and a set of emerging opportunities}. In this embodiment of the present invention, the pre-programmed route can be changed in real time by using a tracking station that keeps communication in real time with a computer of the mobile carrier. Indeed, if the tracking station is configured to receive in real time the update traffic information, it can warn a particular carrier. The carrier can utilize this warning to dynamically adjust the ad that it carriers. For example, the mobile carrier can adjust its ad to target the drivers that are located in close proximity to the mobile carrier in the traffic jam to engineer the maximum real-time exposure. (Example: it can switch an ad from “Coca Cola” to “New Intelligent Book Reading Device”). In another example, if the tracking stations is informed in real time about a set of emerging opportunities, (for instance, there is a panic on the streets due to the announced terror threat), it can transmit this information to a mobile carrier, and the mobile carrier can dynamically adjust the nature of an ad that it carriers. (Example: it can switch an ad from “Coca Cola” to “New Flashlight That Does Not Need Batteries”).

Referring still to FIG. 1, in one embodiment of the present invention, the step (C) (step 16) further comprises: (C1) selecting an ad based on a plurality of factors selected from the group consisting of: {spoken language of the PGR; demographics of the PGR; consumer statistics of the PGR; local variations of the PGR; number of seasons; and time of the day}.

In one embodiment of the present invention, the algorithm configured to estimate revenue stream caused by providing an advertisement (ad) to the targeted PGR should include AI engine configured to select an ad based on the above discussed factors (spoken language of the PGR; demographics of the PGR; consumer statistics of the PGR; local variations of the PGR) plus two obvious factors (number of seasons; time of the day). In addition, the AI engine should be configured to change the selected ad in real time based on the above discussed factors (maximum real-time engineered exposure; and a set of emerging opportunities).

Referring still to FIG. 1, in one embodiment of the present invention, the step (D) (step 18) further comprises: (D1) selecting the mobile carrier of the selected ad from the group consisting of; {a cargo container, a truck; a personal vehicle; and a means of transportation}.

In one embodiment of the present invention, a single mobile carrier is selected based on many factors like: the nature of the goods being transported, the distance to be traveled to reach the destination of the goods, the cost of rent of the vehicle, the cost of fuel, etc. In another embodiment of the present invention, if the ad provider can no afford not to delivery a crucial ad in time to the targer6ted PGR, a replacement mobile carrier that carriers the same ad should be selected in advance to respond in real time to emergencies like: the originally selected mobile carrier brakes down beyond repair, there is a traffic accident in progress, etc.

In one embodiment of the present invention, referring still to FIG. 1, the step (E) (step 20) further comprises: (E1) checking whether the mobile carrier follows the selected route by determining real time position coordinates of the mobile carrier by using a position determination device, wherein the position determination device is selected from the group consisting of {a GPS receiver; a GLONASS receiver; a GALILEO receiver; a Global Navigational Satellite System (GNSS) receiver, and a pseudolite receiver}.

In this embodiment of the present invention, the mobile carrier has to be equipped with at least one position determination device like: a GPS receiver, a GLONASS receiver, a GALILEO receiver, a Global Navigational Satellite System (GNSS) receiver, or a pseudolite receiver.

The Global Positioning System (GPS) is a system of satellite signal transmitters that transmits information from which an observer's present location and/or the time of observation can be determined. The GPS was developed by the United States Department of Defense (DOD) under its NAVSTAR satellite program. Please, see the document ICD-GPS-200: GPS Interface Control Document, ARINC Research, 1997, GPS Joint Program Office, which is incorporated by reference herein.

The second satellite-based navigation system is the Global Orbiting Navigation Satellite System (GLONASS), placed in orbit by the former Soviet Union and now maintained by the Russian Republic.

As disclosed in the European Commission “White Paper on European transport policy for 2010”, the European Union will develop an independent satellite navigation system GALILEO as a part of a global navigation satellite infrastructure (GNSS).

Reference to a radio positioning system (RADPS) herein refers to a Global Positioning System (GPS), to a Global Orbiting Navigation System (GLONASS), to GALILEO System, and to any other compatible Global Navigational Satellite System (GNSS) satellite-based system that provides information by which an observer's position and the time of observation can be determined, all of which meet the requirements of the present invention, and to a ground based radio positioning system such as a system comprising of one or more pseudolite transmitters.

After the RADPS receiver determines the coordinates of i-th satellite by demodulating the transmitted ephemeris parameters, the RADPS receiver can obtain the solution of the set of the simultaneous equations for its unknown coordinates (x₀, y₀, z₀) and for unknown time bias error (cb). The RADPS receiver can also determine velocity of a moving platform.

In one embodiment of the present invention, the position determination device can be implemented by using a pseudolite receiver. The pseudolite comprises a ground based radio positioning system working in any radio frequency including but not limited to the GPS frequencies and the ISM (industrial scientific medical) unlicensed operation band, including 900 MHZ, 2.4 GHz, or 5.8 GHz bands ISM bands, or in a radio location band such as the (9.5-10) GHz band. Pseudolites can be used for enhancing the GPS by providing increased accuracy, integrity, and availability. The complete description of the pseudolite transmitters in GPS band can be found in “Global Positioning System: Theory and Applications; Volume II”, edited by Bradford W. Parkinson and James J. Spilker Jr., and published in Volume 164 in “PROGRESS IN ASTRONAUTICS AND AERONAUTICS”, by American Institute of Aeronautic and Astronautics, Inc., in 1966.

Pseudolites as radio positioning systems can be configured to operate in ISM band. In ISM band, including 900 MHZ, 2.4 GHz, or 5.8 GHz bands, the user can own both ends of the ISM communication system. The ISM technologies are manufactured by Trimble Navigation Limited, Sunnyvale, Calif. Metricom, Los Gatos, Calif. and by Utilicom, Santa Barbara, Calif.

Referring still to FIG. 1, in one embodiment of the present invention, the step (E1) (not shown) further comprises: (E1, 1) sending the real time position coordinates of the mobile carrier to a tracking station; and (E1, 2) recording an actual route of the mobile carrier by the tracking station. In this embodiment of the present invention, the mobile carrier includes a wireless transceiver configured to communicate with the tracking station, and the tracking station includes a wireless transceiver configured to communicate with at least one mobile carrier. In this embodiment of the present invention, the mobile carrier is configured to send its real time position coordinates to the tracking station at certain time intervals (for example, every 1 minute, or every 5 minutes, etc.). In this embodiment of the present invention, the tracking station is configured to record an actual route of at least one mobile carrier that it tracks. In one embodiment of the present invention, the tracking station is configured to compare an actual route of each mobile carrier with its pre-programmed route, and is configured to create a record. The deviations by a mobile carrier from its pre-programmed route should be authorized by the tracking station based on a number of contingences like: maximum real-time engineered exposure, or/and a set of emerging opportunities, as was discussed above.

In one embodiment of the present invention, referring still to FIG. 1, the step (F) (step 22) further comprises: (F1) estimating the revenue stream originated from the targeted PGR and caused by exposure to the selected ad by using a plurality of factors selected from the group consisting of: {a pre-arrangement agreement between a mobile carrier provider and an ad agency; a poll conducted among population of the PGR; and a model of the revenue stream originated from the targeted PGR and caused by exposure to the selected ad}.

### Pre-Arrangement Agreement Between a Mobile Carrier Provider and an Ad Agency.

In one embodiment of the present invention, the algorithm configured to estimate revenue stream caused by providing an advertisement (ad) to the targeted PGR should include AI engine configured to select an ad, configured to select a mobile carrier of selected ad, and configured to select a route based on pre-arrangement agreement between a mobile carrier provider and an ad agency.

In one embodiment of the present invention, the pre-arrangement agreement between the mobile carrier provider and the ad agency is very specific and specifies all the details: the PGR to be targeted, the types of mobile carriers to be used, the ads to be displayed, routes to be used for specific ads designed to target specific PGR, and a number of contingences like: maximum real-time engineered exposure, or/and a set of emerging opportunities, as was discussed above.

In another embodiment of the present invention, the pre-arrangement agreement between the mobile carrier provider and the ad agency is very general and allows the mobile carrier to use its own expertise and judgment to choose the PGR to be targeted, the types of mobile carriers to be used, the ads to be displayed, and also routes to be used for specific ads designed to target specific PGR. In this embodiment of the present invention, the pre-arrangement agreement between the mobile carrier provider and the ad agency provides only the amount of minimum revenue that should be generated within certain time period.

### Poll Conducted Among Population of the PGR.

In one embodiment of the present invention, the algorithm configured to estimate revenue stream caused by providing an advertisement (ad) to the targeted PGR should include AI engine. In this embodiment of the present invention, AI engine is configured to select an ad, configured to select a mobile carrier of selected ad, and configured to pre-program a route of the selected carrier by using, among other factors, at least one poll conducted among population of the targeted PGR.

Opinion polls are surveys of opinion using sampling. They are usually designed to represent the opinions of a population by asking a small number of people a series of questions and then extrapolating the answers to the larger group. For many years, opinion polls were conducted mainly face-to-face, either in the street or in people's homes. This method remains widely used, but in some countries it has been overtaken by telephone polls, which can be conducted faster and more cheaply. Because of the common practice of telemarketers to sell products under the guise of a telephone survey and due to the proliferation of residential call screening devices and use of cell phones, response rates for phone surveys have been plummeting. Mailed surveys have become the data collection method of choice among local governments that conduct a citizen survey to track service quality and manage resource allocation. In recent years, Internet and short message service (SMS, or text) surveys have become increasingly popular, but most of these draw on whomever wishes to participate rather than a scientific sample of the population, and are therefore not generally considered accurate.

### A Model of the Revenue Stream Originated from the Targeted PGR and Caused by Exposure to the Selected Ad.

In one embodiment of the present invention, the algorithm configured to estimate revenue stream caused by providing an advertisement (ad) to the targeted PGR should include AI engine that is configured to experiment with the model of revenue stream caused by providing an advertisement (ad) to the targeted PGR by changing the following parameters of the system: type of ads, type of mobile carrier, type of routes, types of emergencies that require to dynamically change an ad or route of the mobile carrier.

Computational model is a mathematical model in computational science that requires extensive computational resources to study the behavior of a complex system by computer simulation. The system under study is often a complex nonlinear system that simple, intuitive analytical solutions are not readily available. Rather than deriving a mathematical analytical solution to the problem, experimentation with the model is done by changing the parameters of the system in the computer, and by determining the differences in the outcome of the experiments. Theories of operation of the model can be derived/deduced from these computational experiments.

In one embodiment of the present invention, the algorithm configured to estimate revenue stream caused by providing an advertisement (ad) to the targeted PGR includes an optimum model designed to generate maximum revenue stream by providing an advertisement (ad) to the targeted PGR.

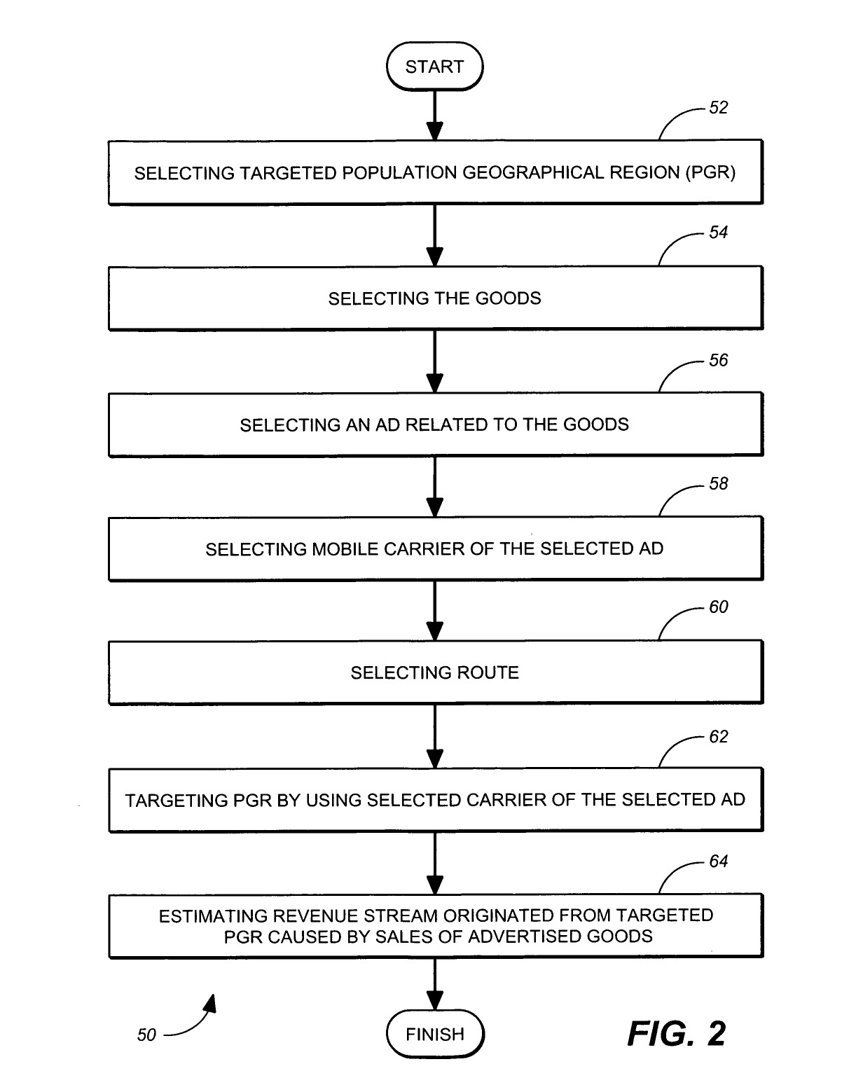

In one embodiment, FIG. 2 illustrates a flow chart 50 of the method of the present invention for generating revenue stream by providing an advertisement (ad) to a targeted populated geographical region (PGR), wherein the selected ad placed on a mobile carrier is related to goods loaded on the mobile carrier, and wherein the selected ad is also indicative of shops where the goods are being delivered.

In one embodiment, as shown in FIG. 2, the method of the present invention comprises: (A) selecting the PGR (step 52); (B) selecting the goods (step 54); (C) selecting an ad related to the goods (step 56); (D) selecting a mobile carrier of the selected ad (step 58); (E) selecting a route (step 60); (F) targeting a PGR by using the selected carrier of the selected ad, wherein the selected carrier of the selected ad follows the selected route and delivers the goods (step 62); and (G) estimating the revenue stream originated from the targeted PGR from sales of the goods and caused by exposure to the selected ad of the goods (step 64).

In one embodiment of the present invention, the step (A) (step 52 of FIG. 2) further comprises: (A1) selecting a PGR based on a plurality of factors selected from the group consisting of: {country of residence of the PGR; spoken language of the PGR; demographics of the PGR; local variations of the PGR; traffic patterns; and consumer statistics of the PGR}. The equivalent embodiment was disclosed above in relation to the step 12 of FIG. 1, and is incorporated by reference herein.

In one embodiment of the present invention, the step (B) (step 54 of FIG. 2) further comprises: (B1) selecting the goods by using a plurality of factors selected from the group consisting of: {demographics of the PGR; local variations of the PGR; and consumer statistics of the PGR}. All of these factors (demographics of the PGR, local variations of the PGR, and consumer statistics of the PGR) were fully disclosed above.

In one embodiment of the present invention, the algorithm configured to estimate revenue stream caused by providing an advertisement (ad) to a targeted PGR, wherein the selected ad placed on a mobile carrier is related to goods loaded on the mobile carrier, and wherein the selected ad is also indicative of shops where the goods are being delivered, should include AI engine configured to take into account demographics of the PGR, local variations of the PGR, and consumer statistics of the PGR.

Referring still to FIG. 2, in one embodiment of the present invention, the step (C) (step 56) further comprises: (C1) selecting an ad related to the goods by using a plurality of factors selected from the group consisting of: {spoken language of the PGR; demographics of the PGR; consumer statistics of the PGR; local variations of the PGR; number of seasons; and time of the day}. The three factors: spoken language of the PGR, demographics of the PGR, consumer statistics of the PGR and local variations of the PGR were discussed above. This discussion is incorporated by reference herein.

The remaining two factors: number of seasons in the PGR, and time of the day are obvious factors. It is assumed that a person skillful in the art of advertisement knows how to take into account these two factors.

In one embodiment of the present invention, the algorithm configured to estimate revenue stream caused by providing an advertisement (ad) to a targeted PGR, wherein the selected ad placed on a mobile carrier is related to goods loaded on the mobile carrier, and wherein the selected ad is also indicative of shops where the goods are being delivered, should include AI engine configured to take into account spoken language of the PGR, demographics of the PGR, consumer statistics of the PGR, local variations of the PGR, number of seasons in the targeted PGR, and time of the day when the goods are being delivered.

Referring still to FIG. 2, in one embodiment of the present invention, the step (D) (step 58) further comprises: (D1) selecting the mobile carrier of the selected ad from the group consisting of; {a cargo container, a truck; a personal vehicle; and a means of transportation}. The equivalent embodiment was disclosed above in relation to the step 18 of FIG. 1, and is incorporated herein.

In one embodiment of the present invention, the step (E) (step 60 of FIG. 2) further comprises: (E1) pre-programming the route of the mobile carrier to target the selected PGR by using a plurality of factors selected from the group consisting of: {demographics of the PGR; local variations of the PGR; traffic patterns; and consumer statistics of the PGR}. The equivalent embodiment was disclosed above in relation to the step 14 of FIG. 1, and is incorporated herein.

In another embodiment of the present invention, the step (E) (step 60 of FIG. 2) further comprises: (E2) pre-programming the route of the mobile carrier to target the selected PGR by using a plurality of factors selected from the group consisting of: {a set of particular locations; and distribution of time intervals spent on the set of particular locations}. The equivalent embodiment was disclosed above in relation to the step 14 of FIG. 1, and is incorporated herein.

In one more embodiment of the present invention, the step (E) (step 60 of FIG. 2) further comprises: (E3) route real-time programming based on a set of real-time factors selected from the group consisting of: {new requests for delivery of selected goods; and a set of emerging opportunities}. In this embodiment of the present invention, it is assumed that the delivered goods generated so much consumer demand, that it is requested that the goods should be immediately delivered again at least to the same location. Thus, in this embodiment of the present invention, the algorithm configured to estimate revenue stream caused by providing an advertisement (ad) to a targeted PGR, wherein the selected ad placed on a mobile carrier is related to goods loaded on the mobile carrier, and wherein the selected ad is also indicative of shops where the goods are being delivered, should include AI engine configured to take into account at least two more factors: new requests for delivery of selected goods, and a set of emerging opportunities. The last factor is broadly phrased and should include all other situations when the demand exceeds the supply.

Referring still to FIG. 2, in one embodiment of the present invention, the step (F) (step 62) further comprises: (F1) checking whether the mobile carrier follows the selected route by determining real time position coordinates of the mobile carrier by using a position determination device, wherein the position determination device is selected from the group consisting of {a GPS receiver; a GLONASS receiver; a GALILEO receiver; a Global Navigational Satellite System (GNSS) receiver; and a pseudolite receiver}. The equivalent embodiment was disclosed above in relation to the step 20 of FIG. 1, and is incorporated herein.

In one embodiment of the present invention, the step (F1) further comprises: (F1, 1) sending the real time position coordinates of the mobile carrier to a tracking station; and (F1, 2) recording an actual route of the mobile carrier by the tracking station. The equivalent embodiment was disclosed above in relation to the step 20 of FIG. 1, and is incorporated herein.

Referring still to FIG. 2, in one embodiment of the present invention, the step (G) (step 64) further comprises: (G1) estimating the revenue stream originated from the targeted PGR from sales of goods and caused by exposure to the selected ad of the goods by using a plurality of factors selected from the group consisting of: {a pre-arrangement agreement between a mobile carrier provider and an ad agency; a pre-arrangement agreement between an ad agency and a shopping center where the goods are sold; a poll conducted among population of the PGR; and a model of the revenue stream originated from the targeted PGR and caused by exposure to the selected ad of the goods}.

The following factor: a poll conducted among population of the PGR, was discussed above in relation to step 22 of FIG. 1. This discussion is incorporated herein.

On the other hand, the factor “a pre-arrangement agreement between an ad agency and a shopping center where the goods are sold” is a factor that is important only for this embodiment of the present invention, and is discussed separately herein. In addition, two more factors that were discussed above “a pre-arrangement agreement between a mobile carrier provider and an ad agency” and “a model of the revenue stream originated from the targeted PGR and caused by exposure to the selected ad of the good” are affected by the new factor “a pre-arrangement agreement between an ad agency and a shopping center where the goods are sold” and should be modified.

More specifically, in this embodiment of the present invention, the pre-arrangement agreement between an ad agency and a shopping center where the goods are sold should include estimations of the minimum and maximum revenues originated due to advertisement of specific goods by the ad agency. The estimations of the minimum and maximum revenues originated due to advertisement of specific goods by the ad agency could be derived (deduced) from the computational experiments. Based on these estimations, the ad agency should make its own pre-arrangement agreement with a mobile carrier provider that takes into account the new parameter: the flexibility of mobile carrier in terms of responses to requests of shopping centers to urgently deliver specific goods for which the demand exceeds the supply.

In this embodiment of the present invention, the model of the revenue stream originated from the targeted PGR and caused by sales of goods due to exposure to the selected ad of the sold goods should also take into account the estimations of minimum and maximum revenues originated due to advertisement of specific goods by the ad agency that are derived (deduced) from the computational experiments.

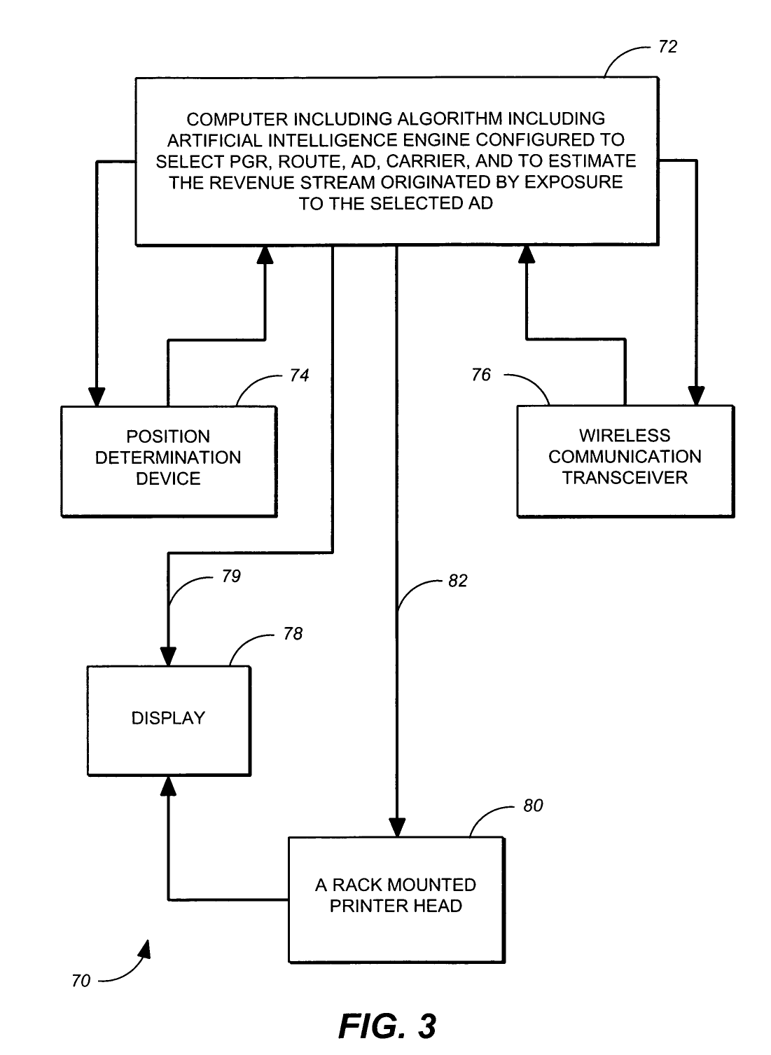

In one embodiment, FIG. 3 illustrates the apparatus 70 of the present invention for generating revenue stream by providing an advertisement (ad) to a targeted populated geographical region (PGR).

In one embodiment, the apparatus 70 of the present invention comprises: a computer 72 including an algorithm including Artificial Intelligence (AI) engine. The AI engine is configured to select PGR, is configured to select a route, is configured to select an ad, is configured to select a mobile carrier of the selected ad, and is configured to estimate revenue stream caused by exposure to the selected ad. The AI engine is also configured to experiment with the choices of routes, ads, and carriers to maximize the revenue stream caused by exposure to the selected ad.

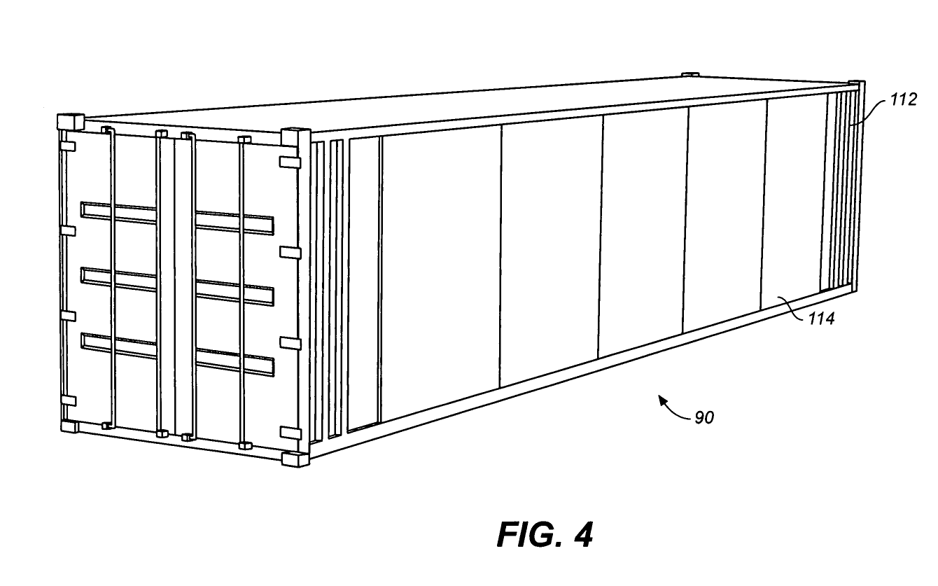

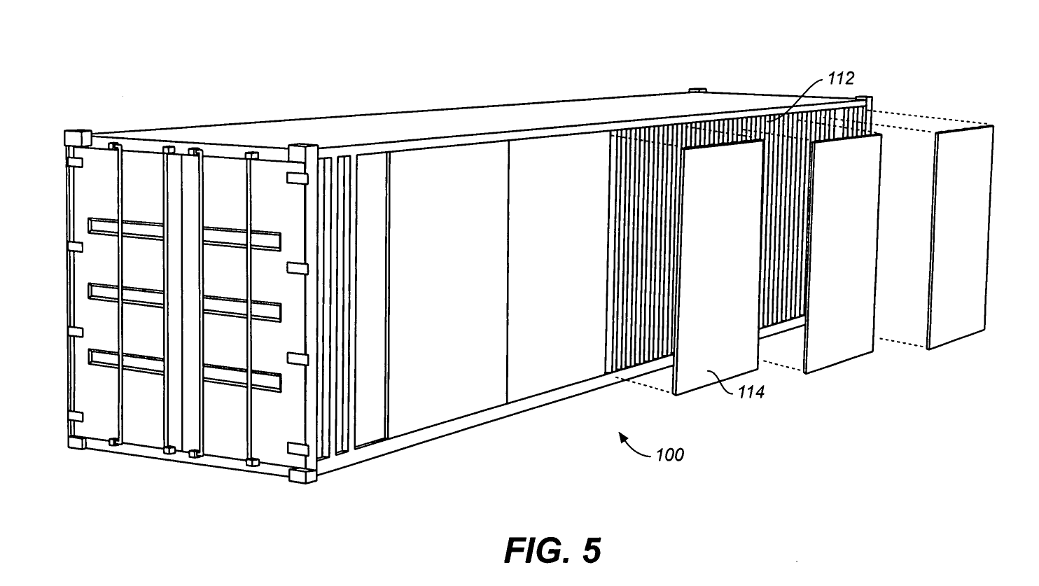

FIG. 4 illustrates as an example a container 90 having five modular panels shown assembled and ready for mounting of advertisement martial. FIG. 5 is an exploded view of assembly process that illustrates how five modular panels can be mounted on the container 100 to create a subsurface for various forms of advertisement. Methods of mounting can include the usage of glues and/or magnets. A mechanical method of mounting is also feasible.

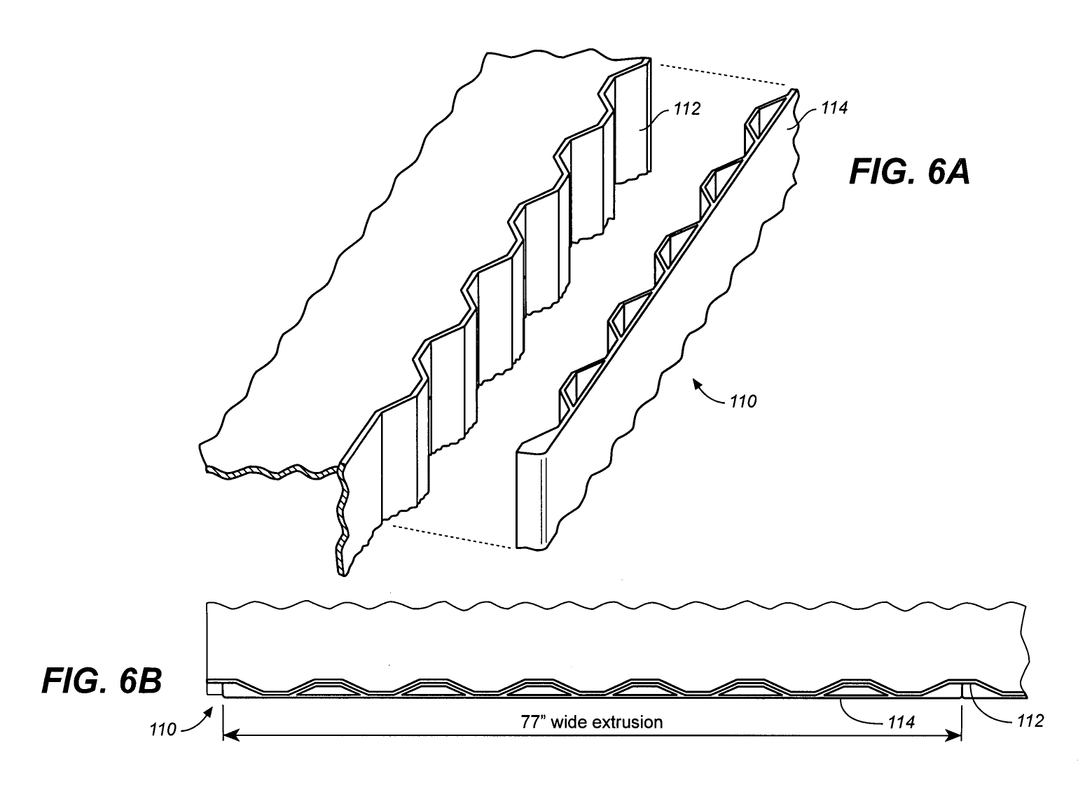

In one embodiment of the present invention, FIG. 6 is an illustration 100 of plastic inserts 114 affixed to the corrugated outer walls 112 of the container in each cavity. In this embodiment of the present invention, the plastic panels 114 (inserts) would flatten out the negative of the corrugated sides 112 of cargo containers for the smooth and easy application of a vinyl wrap. In one embodiment of the present invention, plastic inserts are attached at the top and at the bottom. In another embodiment of the present invention, a pre-manufactured insert includes a thinner plastic overlay to the next positive portion of the corrugation, using a bead of adhesive for the whole length of the insert. An application of a primary plastic wrap to a container as a whole would make the container wall a flat smooth surface suitable for ongoing advertising applications.

Referring still to FIG. 3, in one embodiment, the apparatus 70 of the present invention further comprises: a rack mounted printer head 80 configured to print the selected ad on an external surface of the mobile carrier. In one embodiment of the present invention, the external surface of the mobile carrier includes plastic inserts configured to display an ad as was disclosed above under the control signal 82 from the computer 72.

### EXAMPLE I

The cargo containers are carried in port facilities with a piece of a equipment called “Straddle carriers” (because they straddle the carriers) and with a substructure that has 4 pinions, wherein each pinion fits into one of the holes in each of the four corners. (A pinion is the smallest gear in a gear drive train. In many cases, such as remote controlled toys, the pinion is also the drive gear. The term is also commonly used to describe the smaller gear that drives in a 90-degree angle towards a crown gear in a differential drive.) This straddle carrier system with the substructure could be the same system used to mount two “ink jet” printer cartridges for setting advertising onto each container, for the purpose of getting a true printer alignment. To enable a GPS triggered change in text and images (under a control signal from the computer) there could be 3 or 4 excitable “pixel like” fields that are energized according to GPS coordinates and text requirements.

Referring still to FIG. 3, in one embodiment, the apparatus 70 of the present invention further comprises an electronic display 78 that is configured to display (and to dynamically change) the ad information under the control signal 79 from the computer 72.

Referring still to FIG. 3, in one embodiment, the apparatus 70 of the present invention further comprises a position determination device 74 configured to verify whether the selected carrier of the selected ad follows the selected route. In one embodiment, the apparatus 70 of the present invention, the position determination device is selected from the group consisting of {a GPS receiver; a GLONASS receiver; a GALILEO receiver; a Global Navigational Satellite System (GNSS) receiver; and a pseudolite receiver}.

Referring still to FIG. 3, in one embodiment, the apparatus 70 of the present invention further comprises a transceiver 76 configured to send the real time position coordinates of the mobile carrier to a tracking station (not shown). The tracking station is configured to record an actual route of the mobile carrier.

In one embodiment of the present invention, the wireless transceiver 76 can utilize a communication link selected from the group consisting of: {a cellular link; a radio; a private radio band; a SiteNet 900 private radio network; a wireless Internet; and a satellite wireless communication link}.

The Trimble SiteNet™ 900 private radio network operates in the frequency range of 902-928 MHz, broadcasting, repeating, and receiving real-time data used by Trimble GPS receivers. Under optimal conditions, the SiteNet 900 radio broadcasts data up to 10 km (6.2 miles) line-of-sight and coverage can be enhanced by using a network of multi-repeaters. Using the SiteNet 900 radio as a repeater, enables one to provide coverage in previously inaccessible or obstructed locations. Additionally, SiteNet 900 is license free in the U.S.A. and Canada, which makes it extremely portable.

Referring still to FIG. 3, in one embodiment, the apparatus 70 of the present invention further comprises the computer 72 including an algorithm configured to estimate the revenue stream originated from the targeted PGR and caused by exposure to the selected ad by using a plurality of factors selected from the group consisting of: {a pre-arrangement agreement between a mobile carrier provider and an ad agency; a poll conducted among population of the PGR; and a model of the revenue stream originated from the targeted PGR and caused by exposure to the selected ad}. The revenue stream can be also maximized by changing a plurality of factors selected from the group consisting of: {the selected ad context; the mobile carrier; and the selected route of the carrier of the selected ad context}.

### EXAMPLE II

The Company A (an ad agency) enters into a pre-arrangement agreement between with the Company B (a mobile carrier provider). The Company B's strategy is to pay Company B for delivery ad context and to calculate ad revenue based on actual visibility. Advertisers pay a fixed fee for application of the selected ad graphics to the container (either as paint or vinyl wrap) and then pay monthly fees based on the container's location, with higher rates for best visibility. There is a mutually beneficial relationship and economic alignment among the market participants and stakeholders in the container advertising value chain: (1) Container owners/lessees will be able to substantially monetize their supply chain visibility and security projects by lowering the cost of running their tracking and security infrastructure networks in exchange for allowing their containers to be used as advertising space. (2) Advertisers benefit from a new venue for national and global brand advertising, with fees based on actual exposure. (3) Advertising agencies get a new source of revenue and a new outlet for creativity and differentiation from competitors. (4) The carrier providers receive a steady stream of revenue for the tracking services.

### EXAMPLE III

The Company A contracts the Company B for a number of containers to carry its message for a minimum term of six months. The Company B bills the Company A for utilization, which is estimated to have consumer visibility 20% of the time. After tracking fees ($35/month) and allowance for damage replacement costs, the proposed base rate of $500 per month per container yields an annual gross margin of $750 per container. With an estimated 18 million containers worldwide, the annual total addressable market for container advertising is $13.5 billion.

In one embodiment, FIG. 3 also depicts the apparatus 70 of the present invention configured to generate revenue stream by providing an advertisement (ad) to a targeted populated geographical region (PGR), whereas the selected ad being placed on a mobile carrier is related to goods loaded on the mobile carrier. In this embodiment of the present invention, the selected ad is also indicative of shops where the goods are to be delivered. In this embodiment of the present invention, the computer 72 includes an algorithm including AI engine that is configured to estimate the revenue stream originated from the targeted PGR from sales of the goods and caused by exposure to the selected ad of the sold goods.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents

What is claimed is:

1. A method of generating revenue stream by providing an advertisement (ad) to a targeted populated geographical region (PGR), said ad being placed on a mobile carrier; said method comprising:
(A) selecting said PGR;
(B) selecting a route;
(C) selecting said ad;
(D) selecting a mobile carrier of said ad;
(E) targeting said PGR by using said selected carrier of said ad; wherein said selected carrier of said ad follows said selected route;
and
(F) estimating said revenue stream originated from said targeted PGR and caused by exposure to said ad.

2. The method of claim 1, wherein said step (A) further comprises:
(A1) selecting said PGR based on a plurality of factors selected from the group consisting of: {country of residence of said PGR; spoken language of said PGR; demographics of said PGR; local variations of said PGR; traffic patterns; and consumer statistics of said PGR}.

3. The method of claim 1, wherein said step (B) further comprises:
(B1) pre-programming said route of said mobile carrier to target said PGR by using a plurality of factors selected from the group consisting of: {demographics of said PGR; local variations of said PGR; traffic patterns; and consumer statistics of said PGR}.

4. The method of claim 1, wherein said step (B) further comprises:
(B2) pre-programming said route of said mobile carrier to target said PGR by using a plurality of factors selected from the group consisting of: {a set of particular locations; and distribution of time intervals spent on said set of particular locations}.

5. The method of claim 1, wherein said step (B) further comprises:
(B3) real-time programming said route based on a set of real-time factors selected from the group consisting of: {maximum real-time engineered exposure;
and a set of emerging opportunities}.

6. The method of claim 1, wherein said step (C) further comprises:
(C1) selecting said ad based on a plurality of factors selected from the group consisting of: {spoken language of said PGR; demographics of said PGR; consumer statistics of said PGR; local variations of said PGR; number of seasons; and time of the day}.

7. The method of claim 1, wherein said step (D) further comprises:
(D1) selecting said mobile carrier of said ad from the group consisting of; {a cargo container; a truck; a personal vehicle; and a means of transportation}.

8. The method of claim 1, wherein said step (E) further comprises:
(E1) checking whether said mobile carrier follows said selected route by determining real time position coordinates of said mobile carrier by using a position determination device, wherein said position determination device is selected from the group consisting of {a GPS receiver; a GLONASS receiver; a GALILEO receiver; a Global Navigational Satellite System (GNSS) receiver; and a pseudolite receiver}.

9. The method of claim 8, wherein said step (E1) further comprises:
(E1, 1) sending said real time position coordinates of said mobile carrier to a tracking station;
and
(E1, 2) recording an actual route of said mobile carrier by said tracking station.

10. The method of claim 1, wherein said step (F) further comprises:
(F1) estimating said revenue stream originated from said targeted PGR and caused by exposure to said ad by using a plurality of factors selected from the group consisting of: {a pre-arrangement agreement between a mobile carrier provider and an ad agency; a poll conducted among population of said PGR; and a model of said revenue stream originated from said targeted PGR and caused by exposure to said ad}.

11. The method of claim 1 further comprising:
(G) maximizing said revenue stream originated from said targeted PGR and caused by exposure to said ad by changing a plurality of factors selected from the group consisting of: {said ad context; said mobile carrier; and said selected route of said carrier of said ad context}.

12. A method of generating revenue stream by providing an advertisement (ad) to a targeted populated geographical region, said ad being placed on a mobile carrier; said ad being related to goods loaded on said mobile carrier; said ad being indicative of shops where said goods will be delivered; said method comprising:
(A) selecting said PGR;
(B) selecting said goods;
(C) selecting an ad related to said goods;
(D) selecting a mobile carrier of said ad;
(E) selecting a route;
(F) targeting said PGR by using said selected carrier of said ad; wherein said selected carrier of said ad follows said selected route and delivers said goods;
and
(G) estimating said revenue stream originated from said targeted PGR from sales of said goods and caused by exposure to said ad of said goods.

13. The method of claim 12, wherein said step (A) further comprises:
(A1) selecting said PGR based on a plurality of factors selected from the group consisting of: {country of residence of said PGR; spoken language of said PGR; demographics of said PGR; local variations of said PGR; traffic patterns; and consumer statistics of said PGR}.

14. The method of claim 12, wherein said step (B) further comprises:
(B1) selecting said goods by using a plurality of factors selected from the group consisting of: {demographics of said PGR; local variations of said PGR; and consumer statistics of said PGR}.

15. The method of claim 12, wherein said step (C) further comprises:
(C1) selecting said ad related to said goods by using a plurality of factors selected from the group consisting of: {spoken language of said PGR; demographics of said PGR; consumer statistics of said PGR; local variations of said PGR; number of seasons; and time of the day}.

16. The method of claim 12, wherein said step (D) further comprises:
(D1) selecting said mobile carrier of said ad from the group consisting of; {a cargo container; a truck; a personal vehicle; and a means of transportation}.

17. The method of claim 12, wherein said step (E) further comprises:
(E1) pre-programming said route of said mobile carrier to target said PGR by using a plurality of factors selected from the group consisting of: {demographics of said PGR; local variations of said PGR; traffic patterns; and consumer statistics of said PGR}.

18. The method of claim 12, wherein said step (E) further comprises:
(E2) pre-programming said route of said mobile carrier to target said PGR by using a plurality of factors selected from the group consisting of: {a set of particular locations; and distribution of time intervals spent on said set of particular locations}.

19. The method of claim 12, wherein said step (E) further comprises:
(E3) real-time programming said route based on a set of real-time factors selected from the group consisting of: {{new requests for delivery of said selected goods; and a set of emerging opportunities}.

20. The method of claim 12, wherein said step (F) further comprises:
(F1) checking whether said mobile carrier follows said selected route by determining real time position coordinates of said mobile carrier by using a position determination device, wherein said position determination device is selected from the group consisting of {a GPS receiver; a GLONASS receiver; a GALILEO receiver; a Global Navigational Satellite System (GNSS) receiver; and a pseudolite receiver}.

21. The method of claim 20, wherein said step (F1) further comprises:
(F1, 1) sending said real time position coordinates of said mobile carrier to a tracking station;
and
(F1, 2) recording an actual route of said mobile carrier by said tracking station.

22. The method of claim 12, wherein said step (G) further comprises:
(G1) estimating said revenue stream originated from said targeted PGR from sales of said goods and caused by exposure to said ad of said goods by using a plurality of factors selected from the group consisting of: {a pre-arrangement agreement between a mobile carrier provider and an ad agency; a pre-arrangement agreement between an ad agency and a shopping center where said goods are sold; a poll conducted among population of said PGR; and a model of said revenue stream originated from said targeted PGR and caused by exposure to said ad of said goods}.

23. An apparatus for generating revenue stream by providing an advertisement (ad) to a targeted populated geographical region, said ad being placed on a mobile carrier; said apparatus comprising:
(A) a means for selecting said PGR;
(B) a means for selecting a route;
(C) a means for selecting said ad;
(D) a means for selecting a mobile carrier of said ad;
(E) a means for attaching said ad to an external surface of said mobile carrier;
(F) a means for checking whether said selected carrier of said ad follows said selected route;
and
(G) a means for estimating said revenue stream originated from said targeted PGR and caused by exposure to said ad.

24. The apparatus of claim 23, wherein said means (A) further comprises:
(A1) a means for selecting said PGR based on a plurality of factors selected from the group consisting of: {country of residence of said PGR; spoken language of said PGR; demographics of said PGR; local variations of said PGR; traffic patterns; and consumer statistics of said PGR}.

25. The apparatus of claim 23, wherein said means (B) further comprises:
(B1) an algorithm configured to pre-program said route of said mobile carrier to target said PGR by using a plurality of factors selected from the group consisting of: {demographics of said PGR; local variations of said PGR; traffic patterns; and consumer statistics of said PGR}.

26. The apparatus of claim 23, wherein said means (B) further comprises:
(B2) an algorithm configured to pre-program said route of said mobile carrier to target said PGR by using a plurality of factors selected from the group consisting of: {a set of particular locations; and distribution of time intervals spent on said set of particular locations}.

27. The apparatus of claim 23, wherein said means (B) further comprises:
(B3) an algorithm configured to pre-program in real time said route based on a set of real-time factors selected from the group consisting of: {maximum real-time engineered exposure; and a set of emerging opportunities}.

28. The apparatus of claim 23, wherein said means (C) further comprises:
(C1) an algorithm configured to select said ad based on a plurality of factors selected from the group consisting of: {spoken language of said PGR; demographics of said PGR; consumer statistics of said PGR; local variations of said PGR; number of seasons; and time of the day}.

29. The apparatus of claim 23, wherein said means (D) further comprises:
(D1) an algorithm configured to select said mobile carrier of said ad from the group consisting of; {a cargo container; a truck; a personal vehicle; and a means of transportation}.

30. The apparatus of claim 23, wherein said means (E) further comprises:
(E1) a means for attaching said ad to an external surface of said mobile carrier by using a plastic insert configured to flatten out an external surface of said mobile carrier.

31. The apparatus of claim 23, wherein said means (E) further comprises:
(E2) a rack mounted printer head configured to print said ad on an external surface of said mobile carrier.

32. The apparatus of claim 23, wherein said means (F) further comprises:
(F1) a position determination device configured to verify whether said selected carrier of said ad follows said selected route; wherein said position determination device is selected from the group consisting of {a GPS receiver; a GLONASS receiver; a GALILEO receiver; a Global Navigational Satellite System (GNSS) receiver; and a pseudolite receiver}.

33. The apparatus of claim 32, wherein said means (F1) further comprises:
(F2) a transceiver configured to send said real time position coordinates of said mobile carrier to a tracking station; wherein said tracking station is configured to record an actual route of said mobile carrier.

34. The apparatus of claim 23, wherein said means (G) further comprises:
(G1) an algorithm configured to estimate said revenue stream originated from said targeted PGR and caused by exposure to said ad by using a plurality of factors selected from the group consisting of: {a pre-arrangement agreement between a mobile carrier provider and an ad agency; a poll conducted among population of said PGR; and a model of said revenue stream originated from said targeted PGR and caused by exposure to said ad}.

35. The apparatus of claim 23 further comprising:
(H) a means for maximizing said revenue stream originated from said targeted PGR and caused by exposure to said ad by changing a plurality of factors selected from the group consisting of: {said ad context; said mobile carrier; and said selected route of said carrier of said ad context}.

36. An apparatus for generating revenue stream by providing an advertisement (ad) to a targeted populated geographical region (PGR), said ad being placed on a mobile carrier; said ad being related to goods loaded on said mobile carrier; said ad being indicative of shops where said goods will be delivered; said apparatus comprising:
(A) a means for selecting said PGR;
(B) a means for selecting said goods;
(C) a means for selecting an ad related to said goods;
(D) a means for selecting a mobile carrier of said ad;
(E) a means for selecting a route;
(F) a means for targeting said PGR by using said selected carrier of said ad; wherein said selected carrier of said ad follows said selected route and delivers said goods;
and
(G) a means for estimating said revenue stream originated from said targeted PGR from sales of said goods and caused by exposure to said ad of said goods.

37. A computer-readable storage medium useful in association with an integrated system on-chip; said integrated system on-chip having a processor and memory, said computer-readable storage medium including computer-readable code instructions configured to cause said processor to execute the following algorithm configured to estimate revenue stream caused by providing an advertisement (ad) to a targeted populated geographical region (PGR):
(A) selecting said PGR;
(B) selecting a route;
(C) selecting said ad;
(D) selecting a mobile carrier of said ad;
(E) targeting said PGR by using said selected carrier of said ad; wherein said selected carrier of said ad follows said selected route;
and
(F) estimating said revenue stream originated from said targeted PGR and caused by exposure to said ad.

38. A computer program product that includes a computer-readable medium having a sequence of instructions which, when executed by a processor, causes the processor to execute a process for estimating revenue stream caused by providing an advertisement (ad) to a targeted populated geographical region (PGR); the process comprising:
(A) selecting said PGR;
(B) selecting a route;
(C) selecting said ad;
(D) selecting a mobile carrier of said ad;
(E) targeting said PGR by using said selected carrier of said ad; wherein said selected carrier of said ad follows said selected route;
and
(F) estimating said revenue stream originated from said targeted PGR and caused by exposure to said ad.

39. A computer-readable storage medium useful in association with an integrated system on-chip; said integrated system on-chip having a processor and memory, said computer-readable storage medium including computer-readable code instructions configured to cause said processor to execute the following algorithm configured to estimate revenue stream caused by providing an advertisement (ad) to a targeted populated geographical region (PGR):
(A) selecting said PGR;
(B) selecting said goods;
(C) selecting an ad related to said goods;
(D) selecting a mobile carrier of said ad;
(E) selecting a route;
(F) targeting said PGR by using said selected carrier of said ad; wherein said selected carrier of said ad follows said selected route and delivers said goods;
and
(G) estimating said revenue stream originated from said targeted PGR from sales of said goods and caused by exposure to said ad of said goods.

40. A computer program product that includes a computer-readable medium having a sequence of instructions which, when executed by a processor, causes the processor to execute a process for estimating revenue stream caused by providing an advertisement (ad) to a targeted populated geographical region (PGR); the process comprising:
(A) selecting said PGR;
(B) selecting said goods;
(C) selecting an ad related to said goods;
(D) selecting a mobile carrier of said ad;
(E) selecting a route;
(F) targeting said PGR by using said selected carrier of said ad; wherein said selected carrier of said ad follows said selected route and delivers said goods;
and
(G) estimating said revenue stream originated from said targeted PGR from sales of said goods and caused by exposure to said ad of said goods.
